(19) United States
(12) Patent Application Publication
(10) Pub. No.: US 2021/0394095 A1
(43) Pub. Date: Dec. 23, 2021

(54) FILTER HOUSING ASSEMBLY

(71) Applicant: PA.E Machinery Industrial Co., Ltd., Taichung City (TW)

(72) Inventor: Ming-Yu LAI, Taichung City (TW)

(73) Assignee: PA.E Machinery Industrial Co., Ltd., Taichung City (TW)

(21) Appl. No.: 17/101,116

(22) Filed: Nov. 23, 2020

(30) Foreign Application Priority Data
Jun. 20, 2020 (TW) 109120994

(51) Int. Cl. B01D 35/30; B01D 29/00

(52) U.S. Cl. CPC B01D 35/30; B01D 2201/4023; B01D 29/0029

(57) ABSTRACT

A filter housing assembly is adapted for accommodating a filter element, and includes a housing member and a support structure. The housing member has a cylindrical body, a cap closure, and influent and effluent channels. The support structure includes a first support member that is provided on one of the cylindrical body and the cap closure, and a second support member that is provided on the other one of the cylindrical body and the cap closure. The first and second support members are adapted to be respectively connected to two open ends of the filter element such that one of the open ends is sealed and the other one of the open ends is connected directly to an outlet port of the effluent channel.

### CROSS-REFERENCE TO RELATED APPLICATION

This application claims priority of Taiwanese Patent Application No. 109120994, filed on Jun. 20, 2020.

### FIELD

The disclosure relates to filter housing, more particularly to filter housing for accommodating a filter element therein.

### BACKGROUND

A drinking water or industrial water system will normally be provided with a water filter for filtration of water. An existing water filter includes a filter housing and a filter element replaceably installed in the filter housing. The filter housing includes a housing body, a closure, and a connecting structure unit provided to the housing body and the closure for coupling opposite ends of the filter element.

However, there are various filter elements of different sizes on the market, such as those in compliance with European standards, American standards, or other standards. In order to meet different standards of filter element, different sizes of filter housing need to be prepared; this is inconvenient to users and incurs additional manufacturing cost.

### SUMMARY

Therefore, the object of the disclosure is to provide a filter housing assembly for adaptation to filter element of varied sizes, so as to eliminate the abovementioned inconvenience and extra cost.

According to the disclosure, a filter housing assembly is adapted for accommodating a filter element. The filter element has two open ends, each of which has an annular rim surface. The filter housing assembly includes a housing member and a support structure.

The housing member has a cylindrical body, a cap closure, an influent channel, and an effluent channel. The cylindrical body and the cap closure are arranged along an axis. The cap closure is connected removably to the cylindrical body, and cooperates with the cylindrical body to define an inside space therebetween. The influent and effluent channel are formed in the housing member for communicating the external environment and the inside space. The effluent channel is formed in the cap closure, and has an outlet port that opens to the inside space and that is disposed in the axis.

The support structure is disposed within the inside space, is arranged along the axis, and includes a first support member that is provided on one of the cylindrical body and the cap closure, and a second support member that is provided on the other one of the cylindrical body and the cap closure. The first and second support members are adapted to be respectively connected to the open ends of the filter element such that one of the open ends is sealed and the other one of the open ends is connected directly to the outlet port of the effluent channel. The first support member is cylindrical, surrounds the axis, and has a press end portion that is distal from the one of the cylindrical body and the cap closure and that is adapted to be connected to the annular rim surface of the respective open end of the filter element.

### BRIEF DESCRIPTION OF THE DRAWINGS

Other features and advantages of the disclosure will become apparent in the following detailed description of the embodiments with reference to the accompanying drawings, of which:

FIG. 1 is a cross-sectional view of a first embodiment of the filter housing assembly according to the present disclosure after being combined with a filter element with a relatively shorter length;

FIG. 2 is a partially enlarged view of FIG. 1;

FIG. 3 is a bottom perspective view of a cap closure and a spacer insert of the first embodiment;

FIG. 4 is a perspective view of the spacer insert of the first embodiment;

FIG. 5 is a top view of the spacer insert of the first embodiment;

FIG. 6 is a cross-sectional view of the first embodiment after removing the spacer insert and used with a filter element with a longer length;

FIG. 7 is a fragmentary cross-sectional view of a second embodiment of the filter housing assembly according to the present disclosure;

FIG. 8 is a top view of a spacer insert of the second embodiment;

FIG. 9 is a cross-sectional view of a third embodiment of the filter housing assembly according to the present disclosure;

FIG. 10 is a fragmentary cross-sectional view of a fourth embodiment of the filter housing assembly according to the present disclosure; and

FIG. 11 is a fragmentary cross-sectional view of a fifth embodiment of the filter housing assembly according to the present disclosure.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

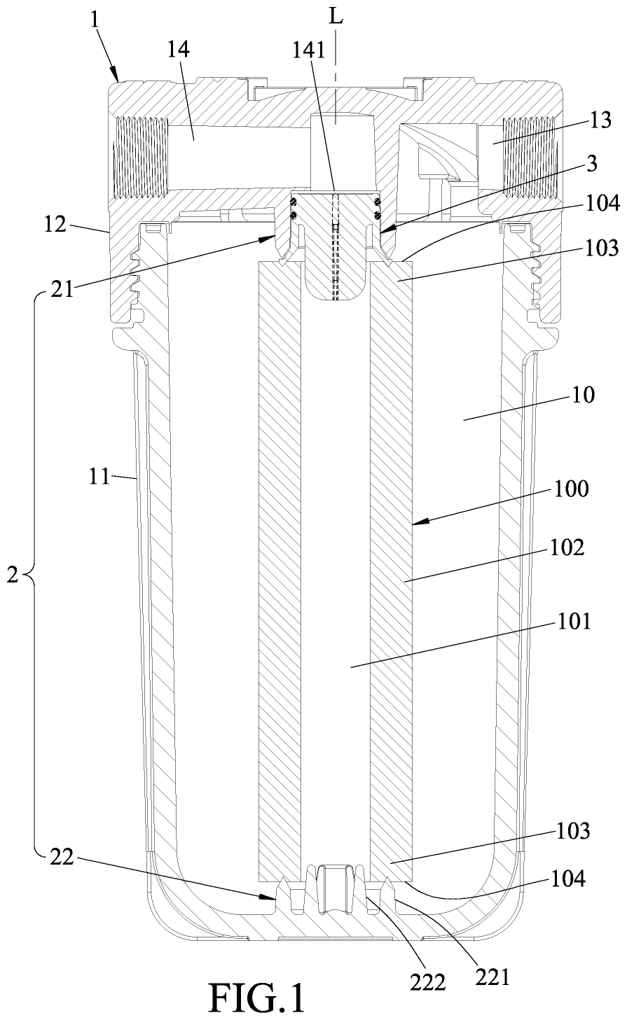

As shown in FIG. 1, in the first embodiment according to the present disclosure, the filter housing assembly is used for accommodating a filter element 100 with a relatively shorter length. The filter element 100 includes a tubular filter media 102 which defines a purified water channel 101, and which has two opposite open ends 103. Each open end 103 has an annular rim surface 104. The filter housing assembly includes a housing member 1, a support structure 2, and a spacer insert 3.

Referring to FIGS. 1 to 3, the housing member 1 includes a cylindrical body 11 and a cap closure 12 that are arranged along an axis (L). The cap closure 12 is connected removably to the cylindrical body 11, and cooperates with the cylindrical body 11 to define an inside space 10 therebetween. The housing member 1 further has an influent channel 13 and an effluent channel 14 for communicating the external environment and the inside space 10. In this embodiment, the influent channel 13 and the effluent channel 14 are both formed in the cap closure 12, the influent channel 13 allows water outside of the housing member 1 to flow into the inside space 10, and the effluent channel 14 allows filtered water to flow out of the inside space 10, but the configuration of the influent channel 13 and the effluent channel 14 is not limited to this. The effluent channel 14 has an outlet port 141 that opens to the inside space 10 and that is disposed in the axis (L).

The support structure 2 is disposed within the inside space 10, and includes a first support member 21 provided on one of the cylindrical body 11 and the cap closure 12, and a second support member 22 provided on the other one of the cylindrical body 11 and the cap closure 12. The first support member 21 and the second support member 22 are arranged along the axis (L), and are adapted to be respectively connected to the open ends 103 of the filter element 100 such that one open end 103 of the filter element 100 is sealed and the other open end 103 is connected directly to the outlet port 141.

In this embodiment, the first support member 21 is provided on the cap closure 12, and the second support member 22 is disposed on the cylindrical body 11. The first support member 21 is cylindrical, surrounds the outlet port 141 and the axis (L), and has a tubular portion 211 projecting from the cap closure 12 toward the cylindrical body 11, and a press end portion 212 connected to the tubular portion 211. Specifically, the press end portion 212 is distal from the cap closure 12, and the tubular portion 211 is connected between the press end portion 212 and the cap closure 12. The press end portion 212 is wedged-shaped, and has two opposite inclined side surfaces 214 and a thin edge 213 interconnecting the inclined side surfaces 214. The press end portion 212 is for being tightly connected to the annular rim surface 104 of the respective open end 103 of the filter element 103. The second support member 22 includes a cylindrical supporting wall 221 disposed around the axis (L) and extended towards the cap closure 12, and a locating post 222 located within the area defined by the cylindrical supporting wall 221. The cylindrical supporting wall 221 is for being pressed against the annular rim surface 104 of the other open end 103 of the filter element 100, with the locating post 222 inserted into the open end 103.

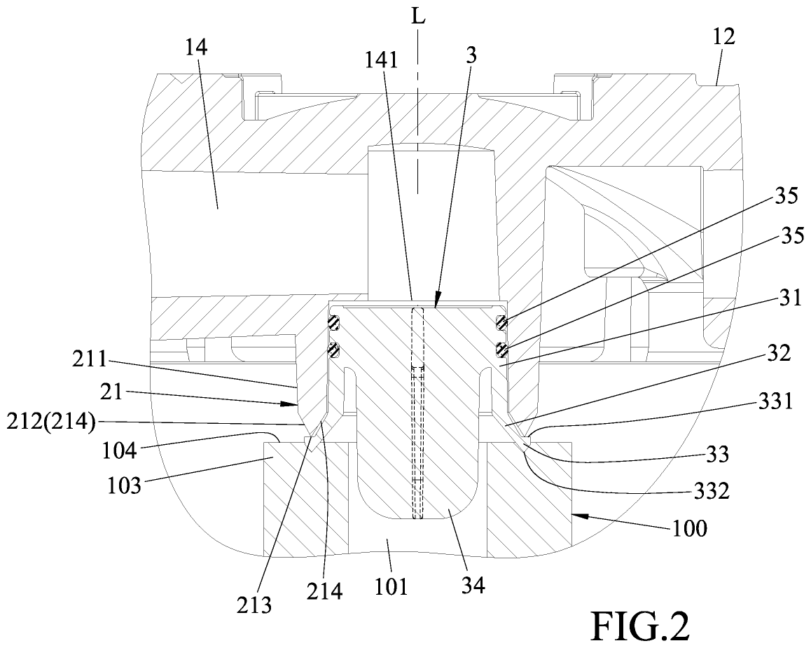

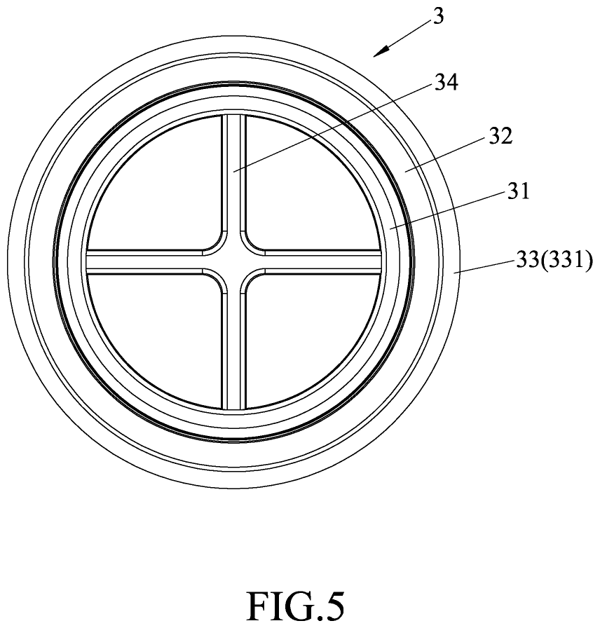

Referring to FIGS. 2, 4 and 5, the spacer insert 3 is adapted to be disposed between the first support member 21 and the filter element 100. The spacer insert 3 includes a fixing skirt portion 31, a deflected portion 32 a gasket portion 33, and a inserting portion 34.

The fixing skirt portion 31 is adapted to be detachably fixed to the first support member 21. In this embodiment, the fixing skirt portion 31 is engaged inside the tubular portion 211 of the first support member 21. The spacer insert 3 further includes at least one O-ring 35 disposed around the fixing skirt portion 31 and abutting sealingly against the tubular portion 211 of the first support member 21. In the exemplary illustration shown in FIGS. 1 and 2, the fixing skirt portion 31 is embedded with two O-rings 35. The fixing skirt portion 31 may also be fixed to the first support member 21 by means of screw locking or snap fit in other embodiments.

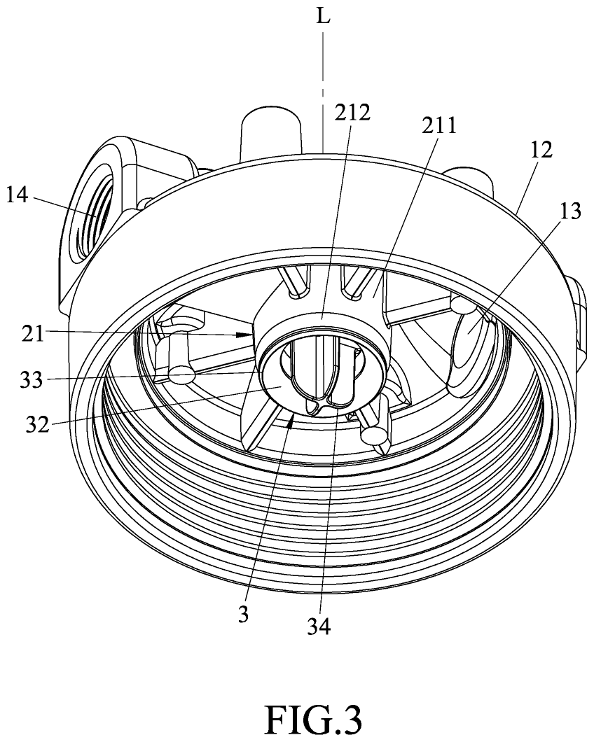

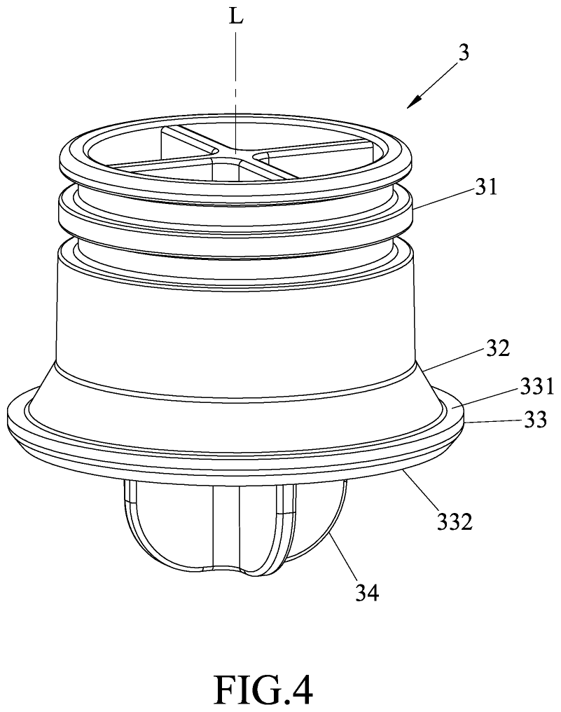

The deflected portion 32 is extended between the fixing skirt portion 31 and the gasket portion 33, is inclined, and abuts against the inner one of the inclined side surfaces 214 of the press end portion 212 of the first support member 21. The gasket portion 33 projects from a lower edge of the deflected portion 32, is disposed at an outer side of the fixing skirt portion 31 with respect to the axis (L), and is adapted to be clamped between the thin edge 213 of the press end portion 212 of the first support member 21 and the respective open end 103 of the filter element 100. The gasket portion 33 is annular shaped, and includes a bearing surface 331 that is substantially perpendicular to the axis (L) and that abuts against the press end portion 212 of the first support member 21, and an annular tapered bottom edge 332 that is opposite to the bearing surface 331 in the direction of the axis (L), and that is adapted to be pressed against the respective open end 103 of the filter element 100. The inserting portion 34 is shaped like a cross-ribbed plug (see FIGS. 3 and 4), extends away from the fixing skirt portion portion 31 along the axis (L) beyond the annular tapered bottom edge 332 of the gasket portion 33, and is adapted to be inserted into the purified water channel 101 of the filter element 100.

Referring to FIGS. 1 to 3, when the filter housing assembly is to be used with the filter element 100 of a shorter length, the spacer insert 3 is firstly fitted into the first support member 21 as shown in FIG. 2, then the filter element 100 is sleeved at an open end 103 on the locating post 222 of the second support member 22, and the annular rim surface 104 of that open end 103 is pressed firmly against the wedged tip of the cylindrical supporting wall 221 of the second support member 22. Afterward, the inserting portion 34 of the spacer insert 3 is fitted to the other open end 103 of the filter element 100, with the annular tapered bottom edge 332 of the gasket portion 33 abutting against the annular rim surface 104 of the corresponding open end 103 of the filter element 100, followed by fixing the cap closure 12 to the cylindrical chamber 11, thus completing the installation of the filter element 100.

When in use, water enters the inside space 10 through the influent channel 13, and then enters the purified water channel 101 through filtration by the tubular filter media 102 of the filter element 100, and the filtered water flows out of the housing member 1 through the effluent channel 14. Since the annular rim surfaces 104 of the two open ends 103 of the filter element 100 are respectively pressed against by the annular tapered bottom edge 332 of the spacer insert 3 and the wedged tip of the cylindrical supporting wall 221 of the second support member 22, the unfiltered water over the annular rim surfaces 104 at the two open ends 103 will be stop from flowing out through the effluent channel 14.

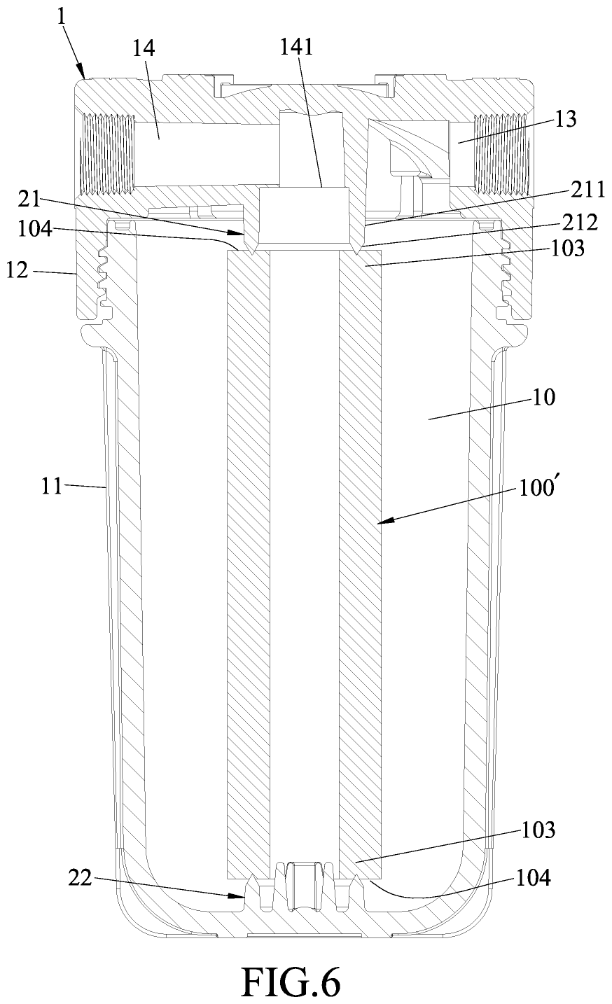

Referring to FIG. 6, when the filter housing assembly is to be used with a longer filter element 100′, the spacer insert 3 is removed so that the press end portion 212 of the first support member 21 is directly pressed against the annular rim surface 104 of the respective open end 103, this can likewise stop the unfiltered water over the annular rim surfaces 104 of the two open ends 103 from flowing out through the effluent channel 14.

The advantages and benefits of this embodiment are summarized as follows:

1. With the spacer insert 3, the filter housing assembly can be used with filter elements of varied lengths; this is convenient for users and allows lower expense.

2. The annular tapered bottom edge 332 of the gasket portion 33 of the spacer insert 3 facilitates the gasket portion 33 to be tightly held against the corresponding annular rim surface 104 of the filter element 100, and the bearing surface 331 of the gasket portion 33 helps to improve stability of the spacer insert 3 clung to the press end portion 212 of the first support member 21 along the axis (L), thereby providing a constant spacing between the first support member 21 and the corresponding open end 103 of the filter element 100.

3. Through the provision of the inserting portion 34 of the spacer insert 3, lateral deflection of the filter element 100 can be avoided.

4. The configuration that the deflected portion 32 of the spacer insert 3 abuts against the inner one of the inclined side surfaces 214 of the press end portion 212 of the first support member 21 helps to prevent unfiltered water from flowing into the effluent channel 14 through the interval between the spacer insert 3 and the first support member 21.

5. The O-rings 35 disposed around the fixing skirt portion 31 further help to prevent unfiltered water from entering the effluent channel 14 through the interval between the spacer insert 3 and the first support member 21.

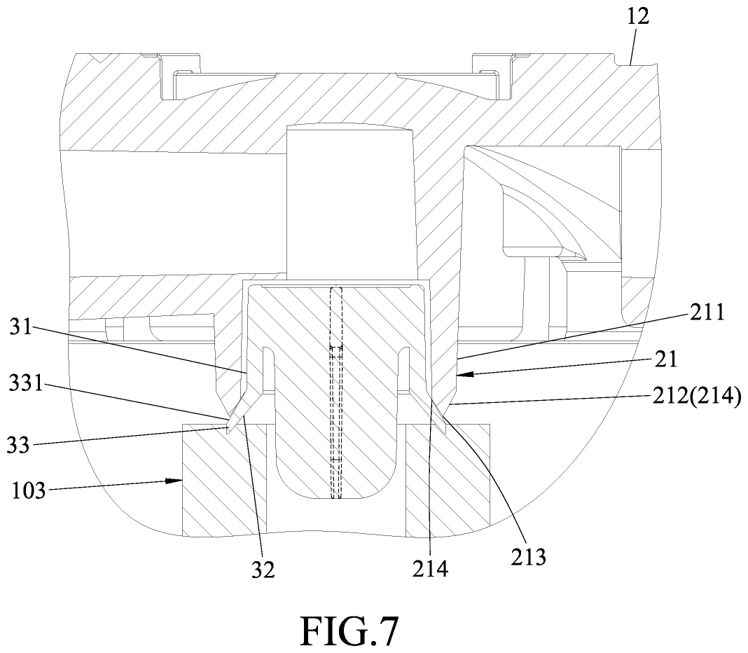

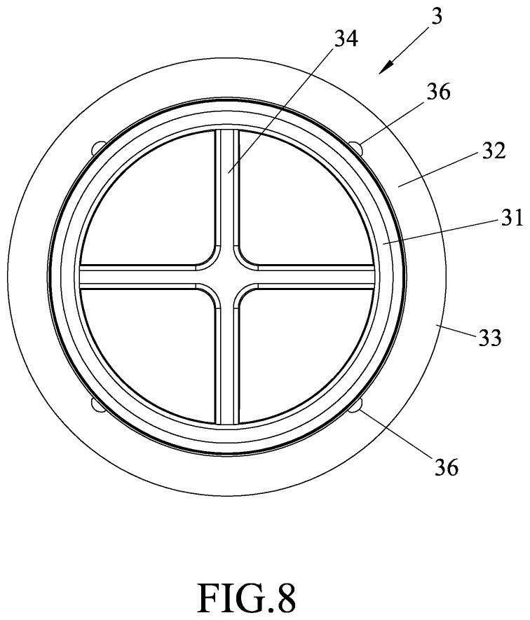

Referring to FIGS. 7 and 8, the second embodiment of the filter housing according to the present disclosure has a structure similar to that of the first embodiment, the differences reside in: the bearing surface 331 of the gasket portion 33 is coplanar with the deflected portion 32. The spacer insert 3 further includes a plurality of protrusions 36 provided on the fixed skirt portion 31 and abutting tightly against the first support member 21.

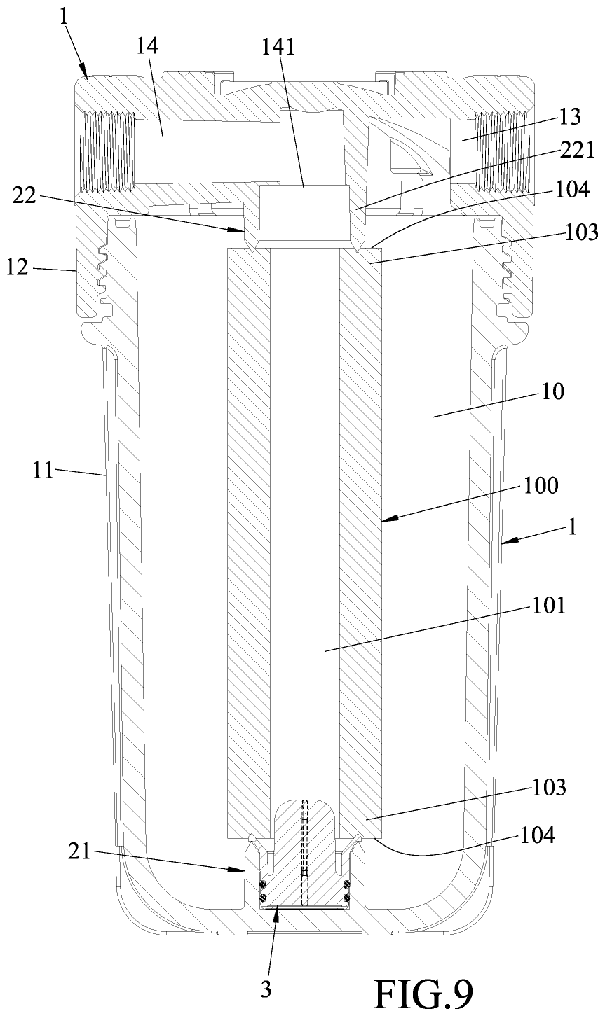

As shown in FIG. 9, the third embodiment of the filter housing according to the present disclosure has a structure similar to that of the first embodiment. The difference between this embodiment and the first embodiment resides in: the first support member 21 is provided on the cylindrical body 11, and the second support member 22 is provided on the cap closure 12. The locating post 222 of the second support member 22 is left out in this embodiment, and the cylindrical supporting wall 221 is disposed to surround the outlet port 141.

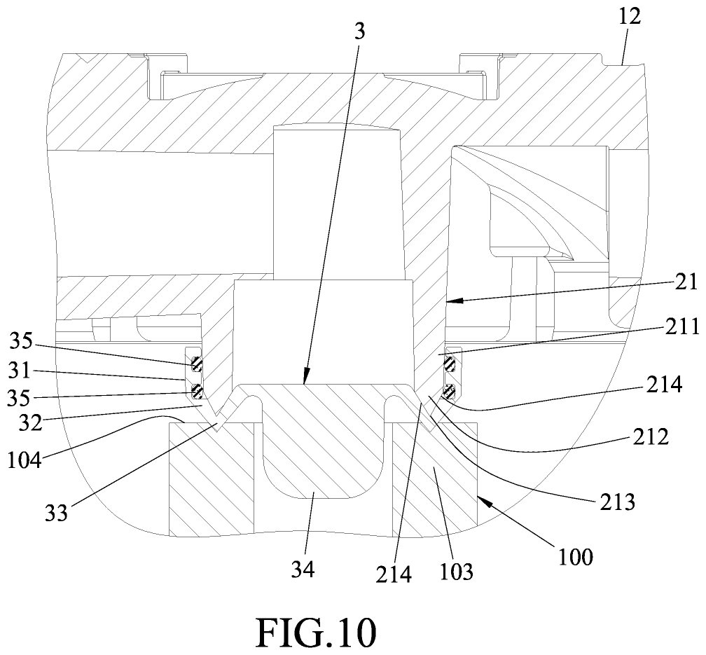

Referring to FIG. 10, the fourth embodiment of the filter housing according to the present disclosure has a structure similar to that of the first embodiment. The difference between this embodiment and the first embodiment resides in: the fixing skirt portion 31 of the spacer insert 3 is sleeved on the outside of the first support member 21, and the O-rings 35 are embedded in the inside surface of the fixing skirt portion 31. The deflected portion 32 is inwardly deflected from the fixing skirt portion 31; the gasket portion 33 is contiguous to the deflected portion 32. The inserting portion 34 is connected with the gasket portion 33.

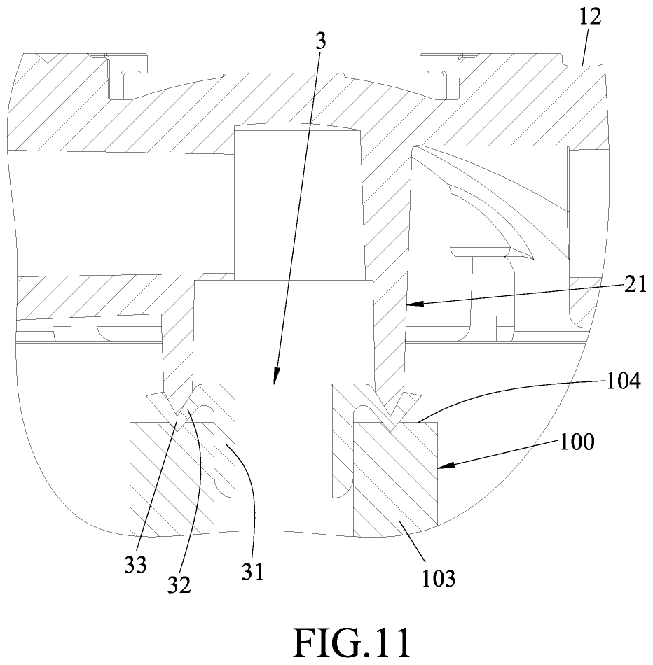

Referring to FIG. 11, the fifth embodiment of the filter housing according to the present disclosure has a structure essentially similar to that of the first embodiment. The difference between this embodiment and the first embodiment resides in: the inserting portion 34 of the spacer insert 3 is left out in this embodiment, and the fixing skirt portion 31 of the spacer insert 3 is inserted into the open end 103 of the filter element 100 corresponding to the first support member 21.

In summary, the filter housing assembly of the present disclosure can be used with filter elements of varied lengths, without needing additional filter housing, thus is convenient and expense-saving for users. Therefore, the purpose of the invention can be indeed achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cap closure various arrangements included within the spirit and scope of the broadest interpretation so as to encompass all such modifications and equivalent arrangements.

What is claimed is:

1. A filter housing assembly adapted for accommodating a filter element that has two open ends, each of the open ends having an annular rim surface, said filter housing assembly comprising:
a housing member having
a cylindrical body and a cap closure that are arranged along an axis, said cap closure being connected removably to said cylindrical body and cooperating with said cylindrical body to define an inside space therebetween, and
an influent channel and an effluent channel formed in said housing member for communicating the external environment and said inside space, said effluent channel being formed in said cap closure and having an outlet port that opens to said inside space and that is disposed in the axis; and
a support structure disposed within said inside space, arranged along the axis, and including a first support member that is provided on one of said cylindrical body and said cap closure, and a second support member that is provided on the other one of said cylindrical body and said cap closure, said first and second support members being adapted to be respectively connected to the open ends of the filter element such that one of the open ends is sealed and the other one of the open ends is connected directly to said outlet port of said effluent channel, said first support member being cylindrical, surrounding the axis, and having a press end portion that is distal from the one of said cylindrical body and said cap closure and that is adapted to be connected to said annular rim surface of the respective open end of the filter element.

2. The filter housing assembly as claimed in claim 1, further comprising a spacer insert adapted to be disposed removably between said first support member and said filter element, and including:
a fixing skirt portion that is adapted to be detachably fixed to one of said first support member and said filter element; and
a gasket portion that is disposed at an outer side of said fixing skirt portion with respect to the axis, and that is adapted to be clamped between said press end portion of said first support member and the respective open end of the filter element.

3. The filter housing assembly as claimed in claim 1, wherein said fixing skirt portion of said spacer insert is engaged inside said first support member.

4. The filter housing assembly according to claim 3, wherein said spacer insert further includes at least one O-ring disposed around said fixing skirt portion and abutting sealingly against said first support member.

5. The filter housing assembly as claimed in claim 3, wherein said spacer insert further includes a plurality of protrusions provided on the fixed skirt portion and abutting against said first support member.

6. The filter housing assembly as claimed in claim 3, wherein said spacer insert further includes an inserting portion extending away from said fixing skirt portion along said axis and beyond said gasket portion, and adapted for insertion into said filter element.

7. The filter housing assembly as claimed in claim 1, wherein said fixing skirt portion of said spacer insert is sleeved on said first support member.

8. The filter housing assembly as claimed in claim 7, wherein said spacer insert further includes an inserting portion extending away from said fixing skirt portion along said axis and beyond said gasket portion, and adapted for insertion into said filter element.

9. The filter housing assembly as claimed in claim 2, wherein said gasket portion of said spacer insert includes a tapered bottom edge that is adapted to be pressed against the respective open end of the filter element.

10. The filter housing assembly as claimed in claim 2, wherein said gasket portion of said spacer insert includes a bearing surface substantially perpendicular to said axis and abutting against said press end portion of said first support member.

11. The filter housing assembly as claimed in claim 2, wherein said gasket portion of said spacer insert is annular-shaped.

12. The filter housing assembly as claimed in claim 2, wherein:
said first support member further has a tubular portion connected between said press end portion and the one of said cylindrical body and said cap closure;
said press end portion of said first support member is wedge-shaped, and has opposite inclined side surfaces and a thin edge interconnecting said inclined side surfaces;
said fixing skirt portion is detachably fixed to said tubular portion of said first support member; and
said spacer insert further includes a deflected portion extended between said fixing skirt portion and said gasket portion, being inclined, and abutting against one of said inclined side surfaces of said press end portion of said first support member.

13. The filter housing assembly as claimed in claim 2, wherein said first support member is provided on said cap closure and surrounds said outlet port.
